(19) United States
(12) Patent Application Publication
(10) Pub. No.: US 2002/0126224 A1
(43) Pub. Date: Sep. 12, 2002

(54) System for detection of transition and special effects in video

(76) Inventor: Rainer Lienhart, Santa Clara, CA (US)

Correspondence Address: Andre M. Gibbs, Blakely, Sokoloff, Taylor & Zafman LLP, Seventh Floor, 12400 Wilshire Boulevard, Los Angeles, CA, 90025-1030, US

(21) Appl. No.: 09/752,261

(22) Filed: Dec. 28, 2000

(51) Int. Cl. H04N 5/14

(52) U.S. Cl. 348/700; 348/578

(57) ABSTRACT

A method and apparatus to detect transition effects are described. A method comprises deriving at least one frame-based video stream, each video stream forms a time series scaled to form a temporal time series pyramid. A fixed-size window slides over the time series. Each fixed-sized time series window is analyzed by a transition detector which determines the probability of a transition effect existing within the window. The time series of transition probabilities are rescaled to the original temporal scale of the video under analysis and integrated into a final transition detection results. Each transition detector is trained by a transition synthesizer to detect transition effects.

### FIELD OF THE INVENTION

The invention relates to the field of multimedia technologies. More specifically, the invention relates to the detection of transition and special effects in videos.

### DESCRIPTION OF THE RELATED ART

The act of detecting transition and special effects in video enables segmentation of video into its basic component, the shots. Typically a shot is considered an uninterrupted or “transition” free video sequence, such as a continuous camera recording. Video editing techniques may use any one of a number of effects to transition from one shot to another. These transition edit types include hard cuts, fades, wipes, dissolves, irises, funnels, mosaics, rolls, doors, pushes, peels, rotates, and special effects. Hard cuts are typically the most common transition effect in videos.

Automatic shot boundary detection techniques attempt to indicate where a transition effect occurs within an edited video stream. The complexity of detecting a shot boundary varies with the type of transition edit used. For example, hard cut, fade and wipe type edits generally require less complex detection techniques compared to dissolves type edits. This is because, in the case of hard cuts and fades, the two sequences involved are temporarily well-separated. Therefore, the detection technique used for hard cuts and fades are often determined by detecting that the video signal is abruptly governed by a new statistical process or that the video signal has been scaled by some mathematically well-defined and simple function (e.g. fade in, fade out).

Even in the case of wipes, the two video sequence involved in the transitions are well-separated at any time. This is typically not the case for a dissolve.

A dissolve is commonly defined as the superposition of a fading out and a fading in sequence. At any time, in regard to dissolves, two video sequences are temporally, as well as spatially intermingled. In order to employ a dissolve's definition directly for detection, the two sequences must be separated. Therefore there is a problem of two source separation.

For example, a dissolve sequence D(x, t) is defined as the mixture of two video sequences S₁(x, t) and S₂(x, t), where the first sequence is fading out while the second is fading in:

D(x,t)=f₁·S₁(x,t)+f₂·S₂(x,t) with t∈[0,T]

Dissolve types are commonly cross-dissolves with

$${f}_{1} = \frac{T - t}{T} , t ∈ [ 0 , T ]$$

$${f}_{2} = \frac{t}{T} , t ∈ [ 0 , T ]$$

and additive dissolves with

$${f}_{1} = \{ \begin{matrix}1 & if ( t \leq {c}_{1} ) \\ \frac{T - t}{T - {c}_{1}} & else\end{matrix} , t ∈ [ 0 , T ] , {c}_{1} ∈ ] 0 , T [ \\ {f}_{2} = \{ \begin{matrix}\frac{t}{{c}_{2}} & if ( t \leq {c}_{2} ) \\ 1 & else\end{matrix} , t ∈ [ 0 , T ] , {c}_{2} ∈ ] 0 , T [$$

In general, three different types of dissolves can be distinguished based on the visual difference between the two shots involved. Regarding a type one dissolve, the two shots involved have different color distributions. Thus, they are different enough such that a hard cut would be detected between them if the dissolve sequence were removed.

Regarding a type two dissolve, the two shots involved have similar color distributes which a color histogram-based hard cut detection algorithm would not detect. However, the structure between the images is different enough in order to be detectable by an edge-based algorithm. For example a transition from one cloud scene to another

Regarding a type three dissolve, the two shots involved have similar color distributions and similar spatial layout. This type of dissolve is a special type of morphing.

Rule-based systems may be beneficial to achieve a computer vision and image understanding but only for simple problems. Existing shot detection methods can be classified as rule-based approaches. A main advantage of rule-based systems are that they usually do not require a large training set. Therefore, automatic shot boundary detection is normally attacked by a rule-based detection system, and not cast as a complex detection problem.

### BRIEF DESCRIPTION OF THE DRAWINGS

The accompanying drawings illustrate embodiments of the invention. In the drawings:

FIG. 1 is a block diagram illustrating an overview of the training components according to one embodiment.

FIG. 2 visualizes the various parameters of the transition generation synthesizer according to one embodiment.

FIG. 3 illustrates a system overview of a transition detection system using a multi-resolution approach according to one embodiment.

FIG. 4 illustrates a typical time series of the edge strength feature according to one embodiment.

FIG. 5 illustrates the performance of the various features for pre-filtering according to one embodiment.

FIG. 6 is a block diagram further illustrating the creation of the training set of block 200 according to one embodiment.

FIG. 7 is a block diagram further illustrating the creation of the training and validation set of block 100 according to one embodiment.

### DETAILED DESCRIPTION OF THE DRAWINGS

The present invention provides for detection of transition and special effects in videos. In the following description, numerous specific details are set forth to provide a thorough understanding of the invention. However, it is understood that the invention may be practiced without these specific details. In other instances, well-known protocols, structures and techniques have not been shown in detail in order not to obscure the invention.

The techniques shown in the figures can be implemented using code and data stored and executed on computers. Such computers store and communicate (internally and with other computers over a network) code and data using machine-readable media, such as magnetic disks; optical disks; random access memory; read only memory; flash memory devices; ASIC, DSP, electrical, optical, acoustical or other form of propagated signals (e.g., carrier waves, infrared signals, digital signals, etch); etc. Of course, one or more parts of the invention may be implemented using any combination of software, firmware, and/or hardware.

One embodiment includes two components: a training system and a transition detection system. The training system includes a transition synthesizer. The transition synthesizer can create from a proper video database an infinite number of transition/special effect examples. In the remainder of the patent application we will use the dissolve transition as an the main example of a transition effect. It should be understood that this is not a restriction. The transition synthesizer is used to create a training and validation set of dissolves with a fixed scale (length) and a fixed location (position) of the dissolve center. These sets are then used to iteratively train an heuristically optimal classifier. For example, in one embodiment, the classifier is accomplished by pattern recognition and machine learning techniques.

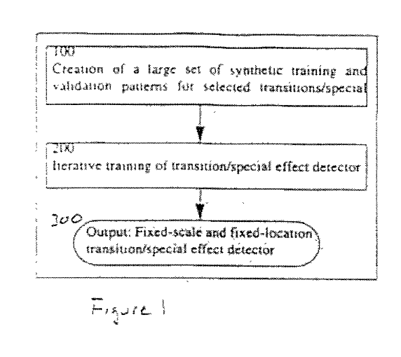

FIG. 1 is a block diagram illustrating an overview of the training components according to one embodiment of the invention. In block 100, the system creates a large set of synthetic training and validation patterns for selected transitions effects, then control passes to block 200. In block 200, the system performs iterative training of transition/effect detector and then control passing to block 300. In block 300, a fixed-scale and fixed-location transition detector is generated.

The significance that synthetic transitions may not be representative for real transitions, is minimal, because all transitions in real videos have been originally generated in exactly the same way. In one embodiment, the video database typically would consist of a diverse set of videos such as home videos, feature films, newscast, soap operas, etc. It serves as the source of video sequences for the transition synthesizer. In the another embodiment, videos in the database are annotated by their transition free video subsequences, shots. This information is provided to avoid the transition synthesizer from accidentally using two video sequences that already contain transition effects. Such a sample would be an outlier in the training set.

In one embodiment a video database can be approximated by adding only videos to the database for which transitions besides hard cuts and fades are rare. Various shot detection algorithms can perform hard cut and fade detection reliably in order to pre-segment the videos and generate the annotations automatically. The probability that a few complex transition effects would be chosen to produce a sample transition is very rare and can thus be ignored.

The transition synthesizer is to generate a random video containing the specified number of transition effects of the specified kind. In one embodiment, the following parameters are given before the synthetic transitions can be created:

N=Number of transitions to be generated

P_{TD}(t)=Probability distribution of the duration of the transition effect

R_{f}, R_{b}=Amount of forward and backward run before and after the transition.

Usually, R_{f}, and R_{b} will be set to the same value.

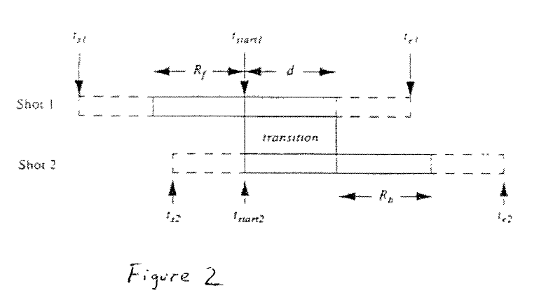

FIG. 2 visualizes the various parameters of the transition generation synthesizer according to one embodiment of the invention as follows:

(1) Read in the list of all videos in the database together with their shot description.

(2) For i=1 to N

(2.1) Randomly choose the duration d of the transitions according to P_{TD}(t)

(2.2) Determine the minimal required duration for both shots as (d+R_{f}) and (d+R_{b}), respectively.

(2.3) Randomly choose both shots S1=[tₛ₁,tₑ₁] and S2=[tₛ₂,tₑ₂] subject to their minimal required duration.

(2.4) Randomly select the start time tₛₜₐᵣₜ₁ and tₛₜₐᵣₜ₂ of the transition for S1 and S2 subject to tₛ₁+R_{f}<tₛₜₐᵣₜ₁<tₑ₁−d and tₛ₂<tₛₜₐᵣₜ₂<tₑ₂−R_{b}−d.

(2.5) Create the video sequence as S1(tₛₜₐᵣₜ₁−R_{f}, tₛₜₐᵣₜ₁)+Transition (S1(tₛₜₐᵣₜ₁, tₛₜₐᵣₜ₁+d), S2(tₛₜₐᵣₜ₂, tₛₜₐᵣₜ₂+d))+S2(tₛₜₐᵣₜ₂+d, tₛₜₐᵣₜ₂+d+R_{b})

In one embodiment the transition effect detection system relies on the fixed-scale, fixed position transition detector developed in the training system. More specifically, a fixed location and fixed duration dissolve classifier is developed where dissolves at different locations and of different duration are detected by re-scaling the time series of frame-based feature values and evaluating the classifier at every location in between two hard cuts.

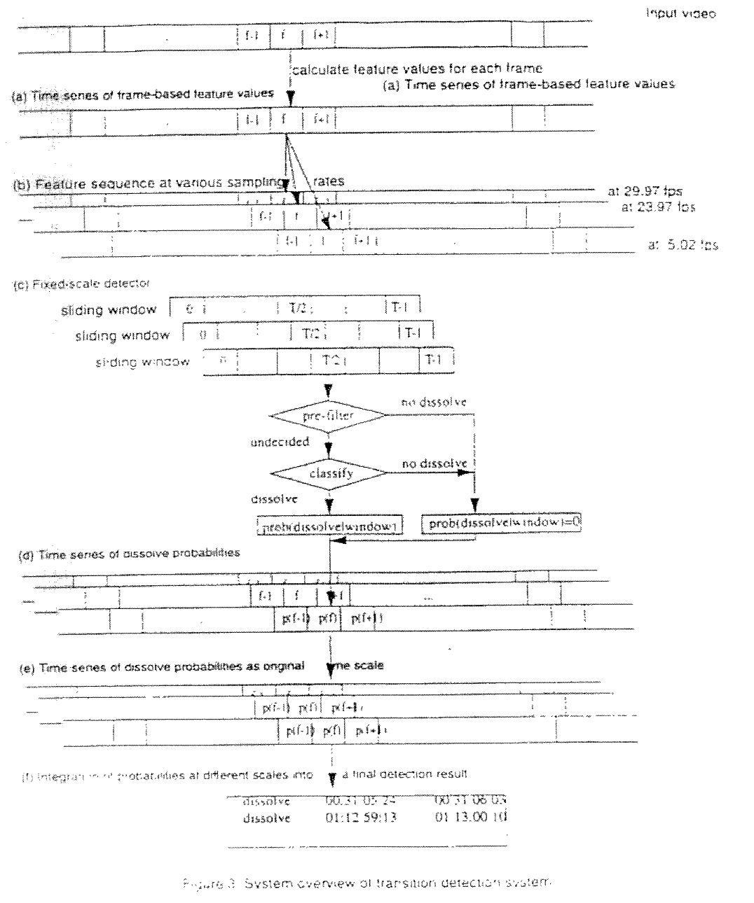

FIG. 3 illustrates a system overview of a transition detection system using a multi-resolution approach according to one embodiment of the invention. First, various frame-based features are derived (FIG. 3(a)). Each frame-based feature forms a time series, which in turn is re-scaled to a full set of time series at different sampling rates creating a time series pyramid (FIG. 3(b)). At each scale, a fixed-size sliding window runs over the time series, serving as the input to a fixed-scale and fixed-position transition detector (FIG. 3(c)). The fixed-scale and fixed position transition detector outputs the probability that the feature sequence in the window belongs to a transition effect. This results in a set of time series of transition effects probabilities at the various scales (FIG. 3(d)). For scale integration, all probability times series are rescaled to the original time scale (FIG. 3(e)), and then integrated into a final answer about the probability of a transition at a certain location and its temporal extend (FIG. 3(f)).

The computational complexity as well as the performance can be improved by specialized pre- and post-filters. The main purpose of the pre-filter besides reducing the computational load is to restrict the training samples to the positive examples and those negative examples which are more difficult to classify. Such a focused training set usually improves the classification performance.

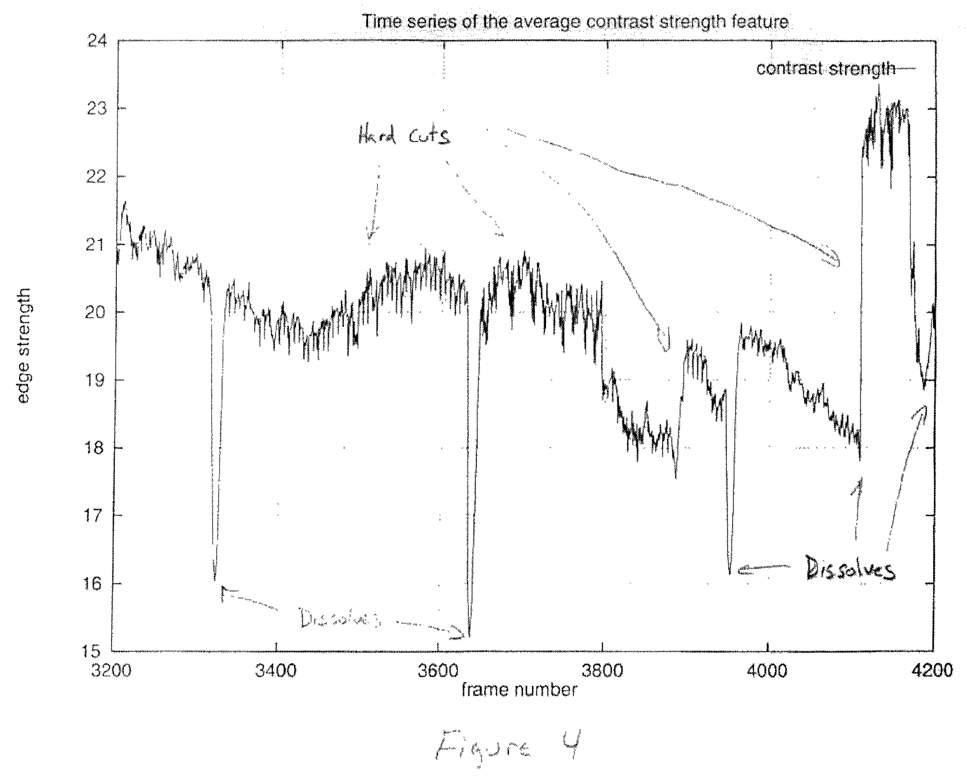

FIG. 4 illustrates a typical time series of the edge strength feature according to one embodiment of the invention. Edge-based Contrast (EC) captures and amplifies the relation between stronger and weaker edges. In FIG. 4, the time series of our dissolve features almost always exhibit a flat graph. Exceptions are sections with camera motion and/or object motion. Thus, the difference between the largest and smallest feature value in a small input window center around the location of interest is used for pre-filtering. If the difference is less than a certain empirical threshold the location will be classified as non-dissolve and is not further evaluated. For multi-dimensional data, the maximum difference between the maximum and minimum in each dimension is used as the criterion. In one embodiment, the input window size is empirically set to 16 frames.

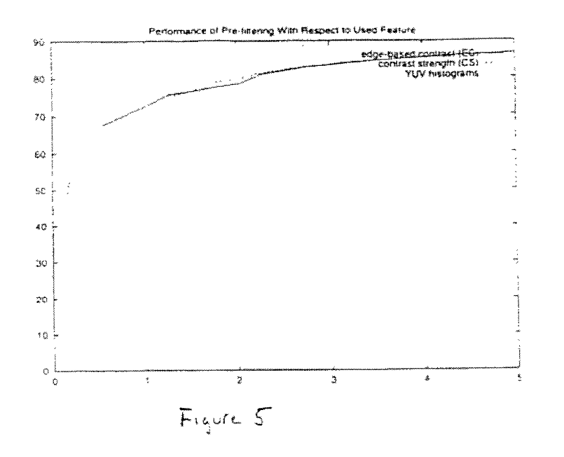

FIG. 5 illustrates the performance of the various features for pre-filtering according to one embodiment of the invention. In general, contrast-based and color-based features respond sometimes differently to typical false alarm situations. Thus, using both kind of features jointly helps to reduce the false alarm rate.

FIG. 5 shows the percentage of falsely discard dissolve location (x-axis) versus the percentage of discard locations (y-axes). Here, the window size was 16 frames and the data has been derived from our large training video set. As can be seen from FIG. 5, the YUV histograms outperformed the other features. In this embodiment, a 24 bin YUV image histogram is used (8 bin per channel, each channel separately) to capture the temporal development of the color content.

Combining YUV histograms with contrast strength (CS) by a simple OR strategy (one of them has to reject the pattern), performs even better, and is chosen as the pre-filter in one embodiment. Generally, the image contrast decreases towards the center of a dissolve and recovers as the dissolve ends. This characteristic pattern can be captured by the time series of the average contrast of each frame. The average contrast strength is measured as the magnitude of the spatial gradient, i.e.,

$${CS}_{avg} ( t ) = \frac{{\sum }_{x ∈ X} {\sum }_{y ∈ Y} {‖ ( \frac{\partial }{\partial x} I ( x , y , t ) , \frac{\partial }{\partial y} I ( x , y , t ) ) ‖}_{2}}{\vert X ‖ Y \vert}$$

For simplicity, also the sum of the magnitude of the directional gradients can be used:

$${CS}_{avg} ( t ) = \frac{{\sum }_{x ∈ X} {\sum }_{y ∈ Y} \vert ( \frac{\partial }{\partial x} I ( x , y , t ) \vert + \vert \frac{\partial }{\partial y} I ( x , y , t ) \vert}{\vert X ‖ Y \vert}$$

However, both of these equations for contrast strength are merely examples and others could be used without departing from the invention.

In another embodiment, the missed rate of accidentally discarded dissolve locations is set to 2%. Note, since dissolves last many frames, discarding 2% of the dissolve locations must not necessarily result in any loss of a dissolve, especially since in one embodiment the fixed-scale and fixed-position classifier is trained to respond not just to the center of a dissolve, but to the four most centered locations. Regardless, the invention is not limited to discarding 2% and other percentages could be used.

Given a 16-tap input vector from the time series of feature values, the fixed scale transition detector classifies whether the input vector is likely to be calculated from a certain type of transition lasting about 16 frames (other embodiments may use a varying number of frames without varying from the essence of the invention). There exist many different techniques for developing a classifier. In the following embodiment, a real-valued neural network with hyperbolic tangent activation function is used with the size of the hidden layer as four, which in turn is aggregated into one output neuron. The value of an output neuron can be interpreted as the likelihood that the input pattern has been caused by a dissolve. However, it should be understood that any kind of machine learning technique could be applied here such as support vector machines, Bayesian learning, and decision trees, or Linear Vector Quantizer (LVQ).

In one embodiment for training and validation, each 10 hours of dissolve videos is synthesized with 1000 dissolves, each lasted 16 frames. The four 16-tap feature vectors around each dissolve's center are used to form the dissolve pattern training/validation set. All other patterns, which do not overlap with a dissolve and are not discarded by the pre-filter, form the non-dissolve training/validation set. Thus, in this embodiment each training and validation set will contain 4000 dissolve examples, and about 20000 non-dissolve examples.

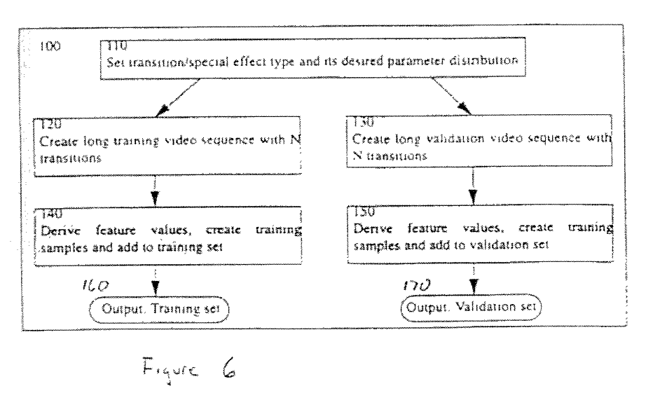

FIG. 6 is a block diagram further illustrating the creation of the training and validation set of block 100 according to one embodiment of the invention. In block 110, the transition effect type and its desired parameter distribution are set. If a training set is to be created then control passes to block 120 from block 110. If a validation set is to be created then control passes to block 130.

In block 120, the system creates a long training video sequence with a given number of transitions and control passes to block 140. In block 140, the feature values are derived, the training samples are created and added to the training set. Control is then passed to block 160. In block 160, the training set is outputted.

In block 130, the system creates a long validation video sequence with a given number of transitions and control passes to block 150. In block 150, the feature values are derived, the training samples are created and added to the training set. Control is then passed to block 170. In block 170, the training set is outputted.

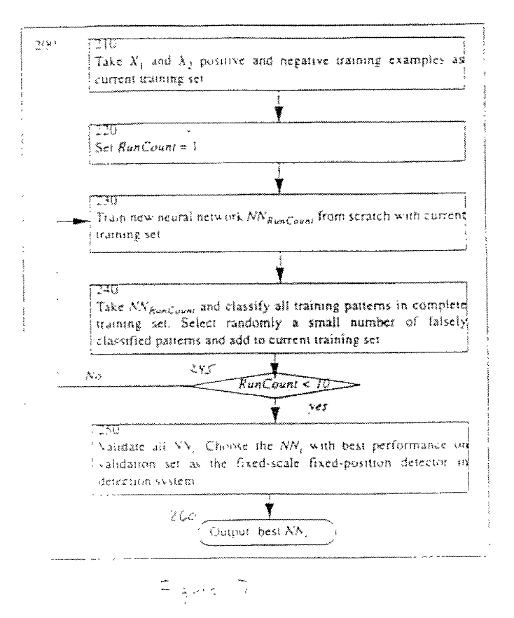

Initially 1000 dissolve patterns and 1000 non-dissolve patterns are selected randomly for training. Only the non-dissolve pattern set is allowed to grow by means of the so-called ‘bootstrap’ method, although other embodiment may use techniques other than the bootstrap method. This method starts with training a neural network on the initial pattern set. Then, the trained network is evaluated using the full training set. Some of the falsely classified non-dissolve patterns of the full training set are randomly added to the initial pattern set and a new, hopefully enhanced neural network is trained with this extended pattern set. The resulting network is evaluated with the training set again and additional falsely classified non-dissolve patterns are added to the set. This cycle of training and adding new patterns is repeated until the number of falsely classified patterns in the validation set does not decrease anymore or nine cycles has been evaluated. Usually between 1500 and 2000 non-dissolve pattern may be added to the actual training set. The network with the best performance on the validation set is then selected for classification. FIG. 7 further illustrates this process. Note that in other embodiments of the system, falsely classified dissolve and non-dissolve patterns are added to the pattern set, not just falsely classified non-dissolves patterns.

FIG. 7 is a block diagram further illustrating the detector training of block 200 according to one embodiment of the invention. In block 210, X₁ positive and X₂ negative training examples are taking as current training sets, then control passes to block 220. In block 220, a run count is set to 1, then control passes to block 230. In block 230, a new neural network is trained with the current training set, then control passes to block 240. In step 240, the trained neural network is used to classify all training patterns. A small number of falsely classified patterns are randomly selected and added to the current training set. Control then passes to block 245. In block 245, if the maximum run count is not reached then control passes back to block 230. However, if the maximum run count is reached then control passes to block 250. In block 250, all classifiers are validated and the neural network with the best performance on the validation set is chosen as the fixed-scale fixed position detector in detection system. In block 260, the best neural network is outputted.

A problem that may be encountered by any dissolve detection method is that there exist many other events that may show the same pattern in the feature's time series. Therefore, in order to reduce the false hits in one embodiment, a restriction is made to detect type one dissolves during post-filtering and, thus check for every detected dissolve whether its boundary frames qualify for a hard cut after its removal from the video sequence. If it does not qualify, then the detected dissolve is discarded.

In addition, in one embodiment it is assumed that the dominant camera motion operation from the video are caused by pans and zooms as determined by the number of false alarms. Thus, all detected dissolves which temporally overlap by more than a specific percentage with a strong dominant camera motion are also discarded during post-filtering. In one embodiment, all detected dissolves which temporally overlap by 70% are discarded.

These two post-filtering criteria help to reduce the false alarm rate and are applied on each scale. In the present embodiment, the output of the post-filtering stage is a list of dissolves with the following parameters: <scale><from><to><prob(dissolve)>.

It is important to note that the fixed-scale and fixed position transition detector may be very selective. That is, it might only respond to a dissolve at one scale. Therefore, in another embodiment a winner-takes-all strategy may be implement. Here, if two detected dissolve sequences overlap, then the one with the highest probability value wins (i.e., the other is discarded). The competition starts at the smallest scale (short dissolves) competing with the second smallest scale and goes up incrementally to the largest (long dissolves).

Wherein embodiments have described in which the transition type “dissolve” is used to demonstrate the new detection system, alternative embodiments could be implemented to demonstrate the invention with other transition types or special effects in videos.

Also wherein embodiments have described in which a neural network classifier is used to demonstrate the new detection system, alternative embodiments could be implemented to demonstrate that a classifier based on other machine learning algorithms such as support vector machines, Bayesian learning, and decision trees could be used instead.

While the invention has been described in terms of several embodiments, those skilled in the art will recognize that the invention is not limited to the embodiments described.

The method and apparatus of the invention can be practiced with modification and alteration within the spirit and scope of the appended claims. The description is thus to be regarded as illustrative instead of limiting on the invention.

I claim:

1. A method of processing video comprising:
acquiring a video stream;
dividing said video stream into a plurality of sub-sections;
determining a probability of whether a transition to a separate sub-section is present at a sub-section of said video stream; and
embedding said probability of said transition into said sub-section of said video stream.

2. The method of claim 1 wherein said determining said probability is performed by a classifier.

3. The method of claim 2 wherein said classifier is provided a fixed-sized portion of said sub-section.

4. The method of claim 1 further comprising outputting a location and duration of said transition in said video stream.

5. The method of claim 1 further comprising a pre-filter component and a post-filter component.

6. The method of claim 1 wherein said transition is a dissolve, a fade, a wipe, a iris, a funnel, a mosaic, a roll, a door, a push, a peel, a rotate, or a special effect.

7. A method of processing video comprising:
acquiring a set of positive and negative training patterns;
generating a set of classifiers with said set of patterns;
recursively training said set of classifiers with said negative training patterns;
validating said set of classifiers; and
selecting one of said classifiers.

8. The method of claim 7 wherein said set of positive training patterns includes a set of transition video streams, and said set of negative training patterns includes a set of transition free video streams.

9. The method of claim 7 wherein said validating said set of classifiers comprises validating said set of classifiers against a set of positive and negative validation patterns, said set of positive validation patterns includes a set of transition video streams, said set of negative validation patterns includes a set of transition free video streams.

10. The method of claim 7 wherein said classifier comprises a real valued feed-forward neural network.

11. A method of processing video comprising:
acquiring at random a video stream comprising at least two separate shots, said separate shots comprising a uninterrupted subset of said video stream;
identifying a sub-section of said separate shots as a first shot transition and a second shot transition, a duration of said shot transitions determined by a transition probability distribution; and
generating a transition sequence comprising said first shot transition and said second shot transition of said duration.

12. The method of claim 11 wherein said transition probability distribution represents a fixed duration.

13. The method of claim 11 wherein said transition sequence is a dissolve, a fade, a wipe, a iris, a funnel, a mosaic, a roll, a door, a push, a peel, a rotate, or a special effect.

14. A video processing apparatus comprising:
a training component, said training component including a transition synthesizer, said transition synthesizer to generate a set of patterns to generate and train an effect detector; and
a detection component coupled to said training component, said detection component coupled to said effect detector to detect an effect.

15. The apparatus of claim 14 wherein said training component comprises a real-valued feed-forward neural network.

16. The apparatus of claim 14 wherein said set of patterns comprises:
a synthetic training pattern; and
a synthetic validation pattern.

17. The apparatus of claim 14 wherein said set of patterns comprises:
a real training pattern; and
a real validation pattern.

18. The apparatus of claim 14 wherein said effect is a dissolve, a fade, a wipe, a iris, a funnel, a mosaic, a roll, a door, a push, a peel, a rotate, or a special effect.

19. A machine-readable medium that provides instructions, which when executed by a set of one or more processors, cause said set of processors to perform operations comprising:
deriving at least one frame-based video stream, each of said frame-based video streams forms a time series stream;
re-scaling said time series stream;
generating a time series stream pyramid from said re-scaled time series stream;
inputting into a classifier a fixed-sized portion of said time series;
receiving from said classifier a transition probability, said transition probability determining the probability of whether a transition effect exist within said fixed-sized portion;
integrating said time series and said transition probability into a transition frame-based probability; and
outputting a location and a duration of said transition effect.

20. The machine-readable medium of claim 19 further comprising a pre-filter component and a post-filter component.

21. The machine-readable medium of claim 19 wherein said time series pyramid includes time series formed from at least one sampling rate to be used by said classifier.

22. The machine-readable medium of claim 19 wherein said receiving said transition probability results in said transition probability generated at various scales.

23. The machine-readable medium of claim 19 wherein said transition effect is a dissolve, a fade, a wipe, a iris, a funnel, a mosaic, a roll, a door, a push, a peel, a rotate, or a special effect.

24. A machine-readable medium that provides instructions, which when executed by a set of one or more processors, cause said set of processors to perform operations comprising:
acquiring a plurality of positive training and validation patterns, said plurality of positive training patterns including a plurality of transition video streams, said plurality of positive validation patterns including a plurality of transition video streams;
acquiring a plurality of negative training and validation patterns, said plurality of negative training patterns including a plurality of transition free video streams, said plurality of negative validation patterns including a plurality of transition free video streams;
generating a set of classifiers using said plurality of positive and negative training patterns to train said set of classifiers;
generating an initial pattern set including a subset of said plurality of training patterns, inserting into said initial pattern set a falsely classified portion of said negative training patterns to train said refined set of classifiers;
validating said set of classifiers against said validation set of negative and positive patterns; and
selecting one of said classifiers.

25. The machine-readable medium of claim 24 wherein said classifier comprises a real-valued feed-forward neural network.

26. A machine-readable medium that provides instructions, which when executed by a set of one or more processors, cause said set of processors to perform operations comprising:
acquiring of a video stream and a probability distribution, said video stream including a shot description;
determining a duration of a transition sequence according to said probability distribution;
selecting a first shot and a second shot, both shots are selected at random; and
generating said video transition sequence of said duration, said video transition sequence including a transition effect.

27. The machine-readable medium of claim 26 wherein said transition effect includes a portion of said first shot and a portion of said second shot.

28. The machine-readable medium of claim 26 wherein said video transition sequence includes a portion of said first shot before said transition effect, said transition effect, and a portion of said second shot after said transition effect.

29. The machine-readable medium of claim 26 wherein said transition effect is a dissolve, a fade, a wipe, a iris, a funnel, a mosaic, a roll, a door, a push, a peel, a rotate, or a special effect.
